(19) United States
(12) Patent Application Publication
(10) Pub. No.: US 2014/0108959 A1
(43) Pub. Date: Apr. 17, 2014

(54) Collaboration Network Platform Providing Virtual Rooms with Indication of Number and Identity of Users in the Virtual Rooms

(71) Applicant: UNISON TECHNOLOGIES, INC., New York, NY (US)

(72) Inventors: Michael Choupak, London (GB); Rurik Bradbury, New York, NY (US); Vladimir Strigun, St. Petersburg (RU); Devidas Desai, Edison, NJ (US); Manlio Carrelli, New York, NY (US)

(73) Assignee: Unison Technologies, Inc., New York, NY (US)

(21) Appl. No.: 13/652,230

(22) Filed: Oct. 15, 2012

(51) Int. Cl. H04L 29/06

(52) U.S. Cl. CPC H04L 65/403
USPC 715/753

(57) ABSTRACT

The present invention extends to methods, systems, and computer program products for implementing a collaboration network platform that provides virtual rooms with an indication of which users of the collaboration network are working within the virtual rooms. A virtual room comprises an organizational unit for grouping users of a collaboration network with respect to a particular subject. For each virtual room within the collaboration network, a count of the number of users and/or a representation of each of the users that are currently working in the virtual room can be maintained and displayed as appropriate. The virtual room can also provide an option to transmit audio and/or video communications in real-time to some or all of the users that are in the virtual room.

### CROSS-REFERENCE TO RELATED APPLICATIONS

Not Applicable.

### BACKGROUND

Social and collaboration networks have become an important part of everyday life for many people. Many use social networks to communicate with friends and family members. Some businesses have also begun using social or collaboration networks to interconnect their employees. Such social and collaboration networks facilitate quick communication among many employees regardless of their physical location. For example, using social or collaboration networks, an employee can post a question, comment, or other information that can be immediately viewed by many different employees thus increasing the ease of collaboration within the business.

### BRIEF SUMMARY

The present invention extends to methods, systems, and computer program products for implementing a collaboration network platform that provides virtual rooms with an indication of the number and/or the identity of users of the collaboration network that are working within the virtual rooms. A virtual room comprises an organizational unit for grouping users of a collaboration network with respect to a particular subject. For each virtual room within the collaboration network, a count of the number of users and/or a representation of each of the users that are currently working in the virtual room can be maintained and displayed as appropriate.

In one embodiment, a user interface of a collaboration network is generated. The user interface includes a list of virtual rooms, each virtual room representing a subject with respect to which a number of users of the collaboration network can collaborate. For at least one of the virtual rooms, an indication of the number of users of the collaboration network that are currently working in the virtual room is generated. The user interface can then be displayed.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention can be implemented;

FIGS. 2-4 illustrate an exemplary user interface of a collaboration network that provides virtual rooms with an indication of the occupants that are currently in each room;

FIG. 5 illustrates a flowchart of an exemplary method for providing an indication of the number of users of a collaboration network that are working within a virtual room in the collaboration network; and

FIG. 6 illustrates a flowchart of a method for generating and transmitting an audio and/or video communication to each user that is currently working within a virtual room in a collaboration network.

### DETAILED DESCRIPTION

The present invention extends to methods, systems, and computer program products for implementing a collaboration network platform that provides virtual rooms with an indication of the number and/or the identity of users of the collaboration network that are working within the virtual rooms. A virtual room comprises an organizational unit for grouping users of a collaboration network with respect to a particular subject. For each virtual room within the collaboration network, a count of the number of users and/or a representation of each of the users that are currently working in the virtual room can be maintained and displayed as appropriate.

In one embodiment, a user interface of a collaboration network is generated. The user interface includes a list of virtual rooms, each virtual room representing a subject with respect to which a number of users of the collaboration network can collaborate. For at least one of the virtual rooms, an indication of the number of users of the collaboration network that are currently working in the virtual room is generated. The user interface can then be displayed.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

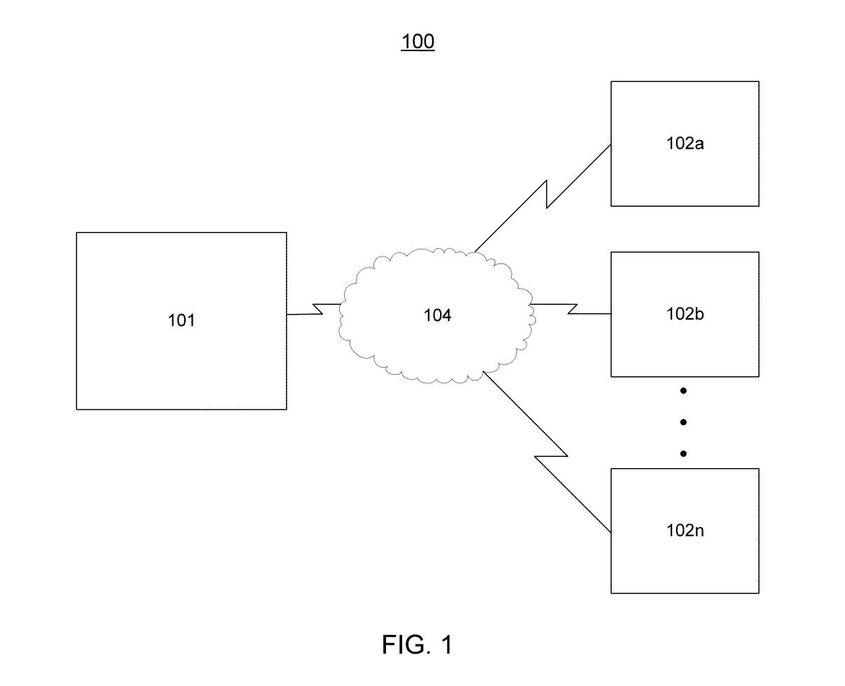

FIG. 1 illustrates an exemplary computer environment 100 in which the present invention can be implemented. Computer environment 100 includes server computing system 101 and client computing devices 102a-102n which are connected via a network 104.

Server computing system 101 provides a collaboration network that a business or other organization can use to facilitate collaboration among its employees or members. A collaboration network can include a social network, an instant messaging network, or any other type of network that allows users to intercommunicate. Server computing system 101 can comprise any number of computer systems or resources. For example, server computing system 101 can be a single server computing system, or can be a cloud of computer resources. Server computing system 101 can provide the collaboration network in any appropriate format such as a website, an application (whether local or web-based), a service, etc.

Client computing devices 102a-102n can represent any type of computing device capable of communicating with server computing system 101 over network 104. Examples of client computing devices 102a-102n include desktop computers, laptop computers, tablets, mobile phones, other smart electronic devices, etc. Client computing devices 102a-102n can access the collaboration network provided by server computing system 101 using a browser (such as when the collaboration network is accessible as a website or web-based application), a dedicated application hosted locally that receives data from server computing system 101, or any other type of configuration known in the art.

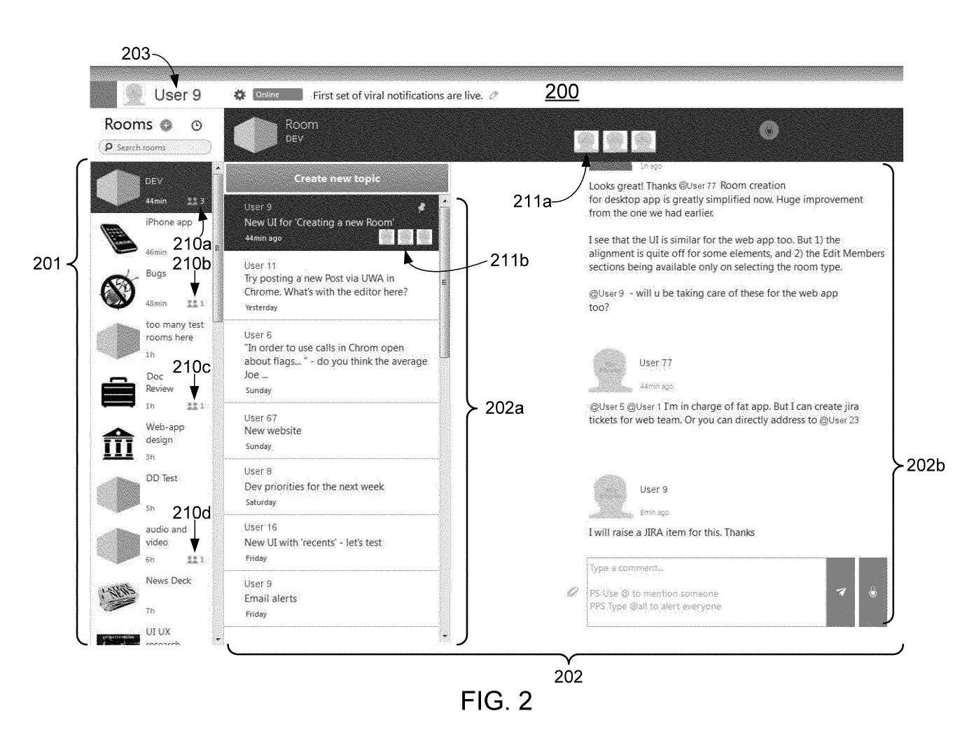

FIG. 2 illustrates an exemplary user interface 200 of a collaboration network according to one or more embodiments of the invention. Exemplary user interface 200 includes a rooms section 201, and a current room section 202.

Rooms section 201 provides a list of available rooms. In exemplary user interface 200, the user is User 9 as indicated by user indication 203. A user can “enter” and “work in” any room listed in rooms section 201. Each room in rooms section 201 can be associated with a particular topic or grouping. For example, a room can be maintained for a department, a project, a subject, or any other grouping or topic.

As shown, rooms section 201 lists rooms having subjects or topics of DEV, iPhone app, Bugs, to many test rooms here, Doc Review, Web-app design, DD test, audio and video, News Deck, UI UX, etc. At least some of the users of the collaboration network can be allowed to create new rooms including defining the scope of newly created rooms. For example, a room can be created having a company-wide scope thus allowing anyone in the company (e.g. anyone having a specified domain name in their email address) to enter the room. A room can also be created having a more restricted scope such as being limited only to specified users or groups of users.

In user interface 200, User 9 has entered the DEV room as indicated by current room section 202 displaying the content of the DEV room (if no room is selected in rooms section 201, current room section 202 could be blank or display content that is not specific to any particular room). The content that can be displayed within current room section 202 includes a list of topics 202a that have been created as well as a list of comments 202b for a selected topic. Current room section 202 can also display other content such as documents, links, controls, etc.

In FIG. 2, the selected topic in list 202a is the “New UI for Creating a new Room” which was created by User 9. Accordingly, list of comments 202b in room section 202 displays comments that have been made within the “New UI for Creating a new Room” topic.

The collaboration network of the present invention provides an indication of who is working where by listing the number of users that are currently in a particular room. For example, the list of rooms in rooms section 201 includes indicators 210a-210d which represent the number of users that are currently working in the corresponding room. In FIG. 2, three users are currently working in the DEV room, one user is currently working in the Bugs room, one user is currently working in the Doc Review room, and one user is currently working in the audio and video room.

In some embodiments, a user is working in a room when the user has clicked on the room in the rooms section 201 thereby causing the room to be displayed within current room section 202. FIG. 2 also illustrates that room section 202 can also include an indicator 211a identifying which users are currently working within the room. For example, because the DEV room currently contains three users, indicator 211a includes three photos (or photo placeholders in this case), one photo for each of the users currently working in the DEV room. Although indicators 211 include photos in the Figures, other forms of indicators could also be used to identify a user as is known in the art (e.g. an icon, avatar, username, etc.)

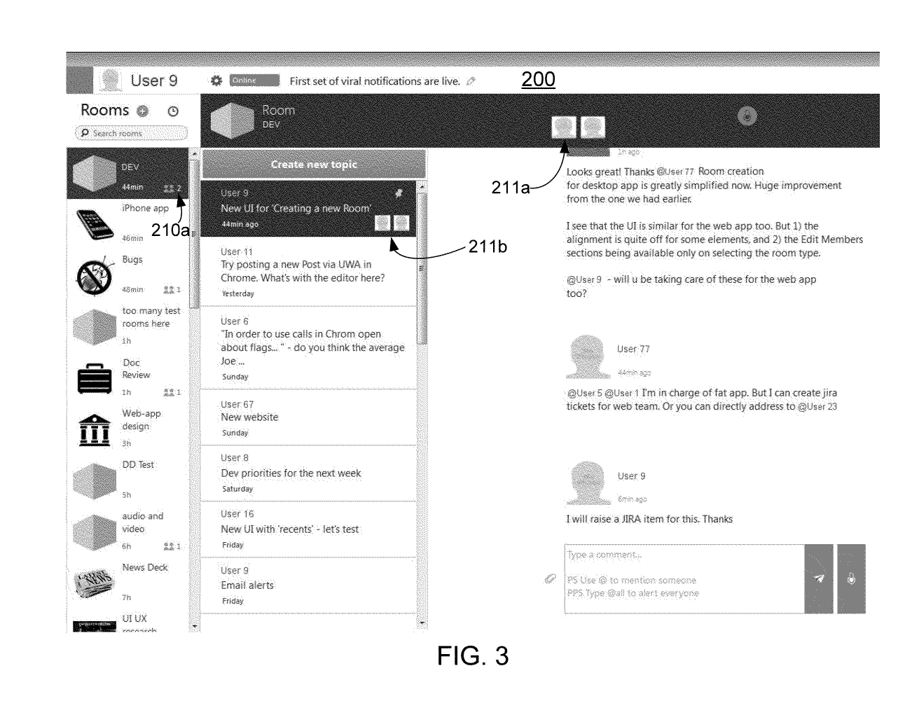

FIG. 3 illustrates user interface 200 after one of the three users shown in FIG. 2 has left the DEV room. As shown, indicator 210a has been updated to display two as the number of users that are currently working in the DEV room. Also, indicators 211a and 211b have been updated to remove the photo of the user that has left the room such that only the photos of the two remaining users in the DEV room are displayed.

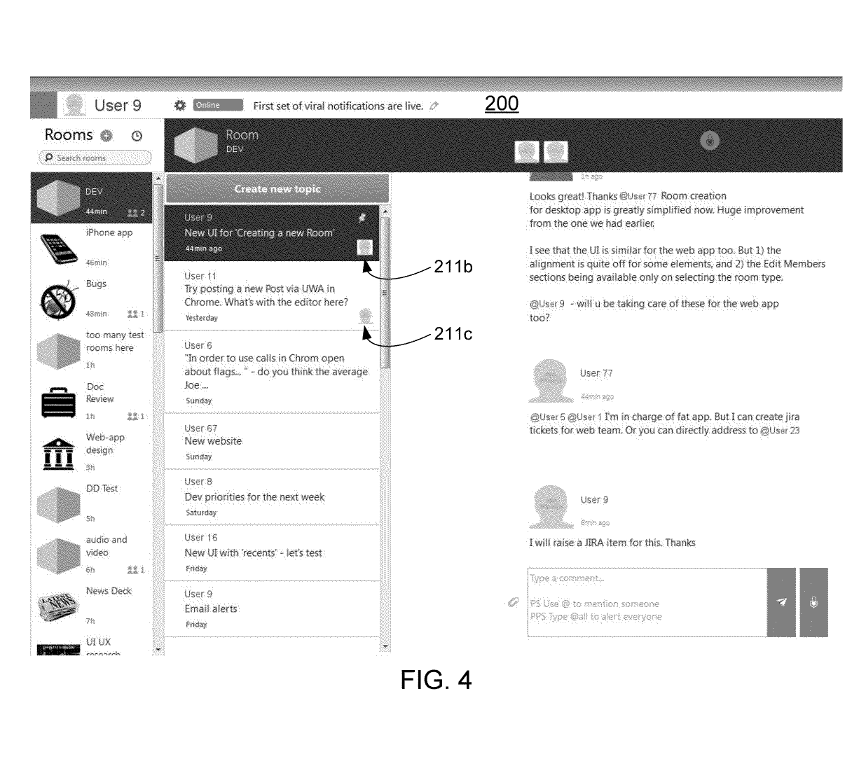

In some embodiments, additional indicators 211b can be provided within the list of topics 202a indicating which users are viewing which topics. In FIGS. 2 and 3, each of the users in the DEV room is viewing the same topic. Accordingly, a single indicator 211b is included showing that all users in the DEV room are working within the “New UI for Creating a new Room” topic. FIG. 4, in contrast, illustrates user interface 200 of FIG. 2 after one of the three users has selected the “Try posting a new Post . . . ” topic. Accordingly, user interface 200 in FIG. 4 includes indicators 211b and 211c which each include a single photo of the user that is currently working within the corresponding topic.

Indicators 210 and 211 provide a quick means for identifying where people are working within a business or organization. For example, by viewing indicators 210 within the list of rooms 201, a user can quickly identify any rooms in which a large number of users are currently working (e.g. to identify rooms of current importance or rooms having large activity). Once within a room (or prior to entering a room in some embodiments), a user can quickly identify the specific users that are in the room (and in some embodiments, within a particular topic in a room) via indicators 211.

These indicators increase the likelihood of serendipitous connections (i.e. the ability to bump into a colleague located anywhere around the world within the context of a particular project, subject, or topic). For example, if a user has a question or comment for another user regarding a particular topic, the user can easily identify an opportune moment to present the question or comment by identifying when the other user is working within the room or even the topic to which the question or comment relates.

The use of rooms also facilitates collaboration and cooperation within a group by grouping questions and comments within the appropriate context. For example, a question regarding a particular topic can be presented within the topic in an appropriate room. By posing questions within a specific context in this manner, other users can more quickly and easily identify how to respond to such questions thereby increasing the efficiency of a group.

In cases where a larger number of users are within a particular room, indicator 211a can display a subset of current users in the room along with a control for scrolling through, expanding, or otherwise changing the photos that are displayed. For example, if indicator 211a is configured to display a maximum of six photos at any given time, indicator 211a can also include one or more controls for scrolling through a list of the photos of all users in the room. Alternatively, indicator 211a can be expandable (e.g. when clicked on or hovered over) to display additional photos of users in the room. Indicator 211b can also be configured in a similar manner to allow a user to view additional photos beyond those initially shown.

As stated above, a user can be considered as working within a room when the user has selected the room from the list of rooms 201 thereby causing the contents of the room to be displayed within current room section 202. In some embodiments, the collaboration network of the present invention can contain additional logic for determining the presence of a user within a room. For example, presence in a room can also be based on activity within the room. In such cases, a user may not be deemed present in a room until the user has interacted in some way with the content of the room (e.g. by selecting, adding, removing, or otherwise interacting with some content within current room section 202).

Further, in some embodiments, presence in a room can also be based on the duration of time since the user last interacted with content in the room. For example, if a user, after entering a room, has not interacted with the content of the room for a specified time period, the user can be deemed as having left the room.

Also, in some embodiments, different levels of presence within a room can be presented for each user. For example, indicators 211 can also include an identification of the current status of the users within a room. Such status can include the duration of time since the user last interacted with the computer, with the software in general (i.e. status may be based on interaction with software whether the interaction is with content within the room or not), or with content of the room (e.g. a duration of time since entering the room, a duration of time since entering the topic, a duration of time since posting a comment, etc.). This status can be represented in various ways as is known in the art (e.g. by including with the photo a count of the number of minutes since last activity, by applying a shading or color to the photo or an indicator associated with the photo that identifies status).

In this manner, the collaboration network of the present invention, in addition to showing who is present in a room/topic, can show who is currently most active within the room/topic. In some embodiments, different status indicators can be maintained for the user's status within a room and within a topic in the room. For example, referring to FIG. 4, if a first user has been within the DEV room for 10 minutes, but has only been within the “Try posting a new Post . . . ” topic for 2 minutes, the photo for the user within indicator 211a can indicate a presence of 10 minutes within the room while the photo for the user within indicator 211b can indicate a presence of 2 minutes within the topic.

In some embodiments, user interface 200 can also include functionality for allowing a user that is working within a room or topic to transmit an audio and/or video communication to some or all of the users that are currently working within the room or topic. For example, a button or other control can be displayed within user interface 200 or a related user interface that, when selected, commences the capture and streaming of audio and/or video data from one client computing device to the client computing devices of other users currently working in the room or topic.

Such audio and/or video content can be displayed immediately upon receipt by the client computing devices of the other users currently working in the room, or can be stored until the user selects to view and/or listen to the content. In this manner, a user can quickly communicate verbally and/or visually with each user working within the room or topic. When one user receives an audio and/or video message from another user, the user can immediately respond with his own audio and/or video message that can be transmitted to one or more users in the virtual room. In this manner, user interface 200 facilitates the initiation of group communications.

User interface 200 can include an indication of the users and/or number of users that are participating within a group communication. For example, when less than all users within a room are participating in a group communication, an indication of which users are participating can be provided that is separate from the indication of all users that are within the room and/or topic. This indication can also identify who is currently speaking or otherwise providing content for the group communication as well as who is receiving the content (e.g. listening to or watching the content of the group communication).

In some embodiments, user interface 200 can also provide functionality to allow a user to select the representation (e.g. 211a or 211b) of another user to commence communicating with the other user. For example, when a representation 211a of a user is selected, user interface 200 can provide a user interface element in which the user and the selected user can communicate one on one. Because the selection of the user is made in the context of a room or topic, this functionality simulates pulling someone aside in a physical room to privately discuss a topic being discussed by all participants in the room.

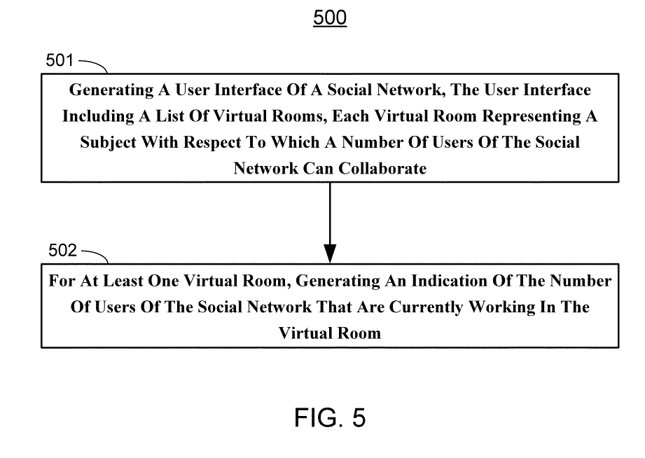

FIG. 5 illustrates a flowchart of an exemplary method 500 for providing an indication of which users of a collaboration network are working within a virtual room in the collaboration network. Method 500 will be described with reference to the Figures. Method 500 can be implemented by server computing system 101 in the form of a website that is displayed to users of client computing devices 102-102n, by client computing devices 102a-102n in the form of an application that displays content received from server computing system 101, or using other configurations as is known in the art.

Method 500 includes an act 501 of generating a user interface of a collaboration network, the user interface including a list of virtual rooms. Each virtual room represents a subject with respect to which a number of users of the collaboration network can collaborate. For example, server computing system 101 and/or one or more of client computing devices 102a-102n can generate a user interface, similar to user interface 200 shown in FIGS. 2-4, that includes a list of rooms 201.

Method 500 includes an act 502 of, for at least one virtual room, generating an indication of the number of users of the collaboration network that are currently working in the virtual room. For example, the indication of the number of users can comprise indicator 210a or indicator 211a. As such, the indication, in some embodiments, can comprise a count of the number of users in a room as well as an identifier for each of the users in the room.

Method 500 can be implemented by server computing system 101 by generating instructions for rendering the user interface, and sending the instructions to one or more client computing devices to allow the client computing devices to display the user interface to users. Method 500 can also be implemented by one or more of client computing devices 102a-102n by generating (e.g. using information received from server computing system 101 or another of client computing devices 102a-102n) or receiving instructions for rendering the user interface, and rendering the instructions to display the user interface. Accordingly, method 500 should not be limited to any particular computer architecture, protocol, or location.

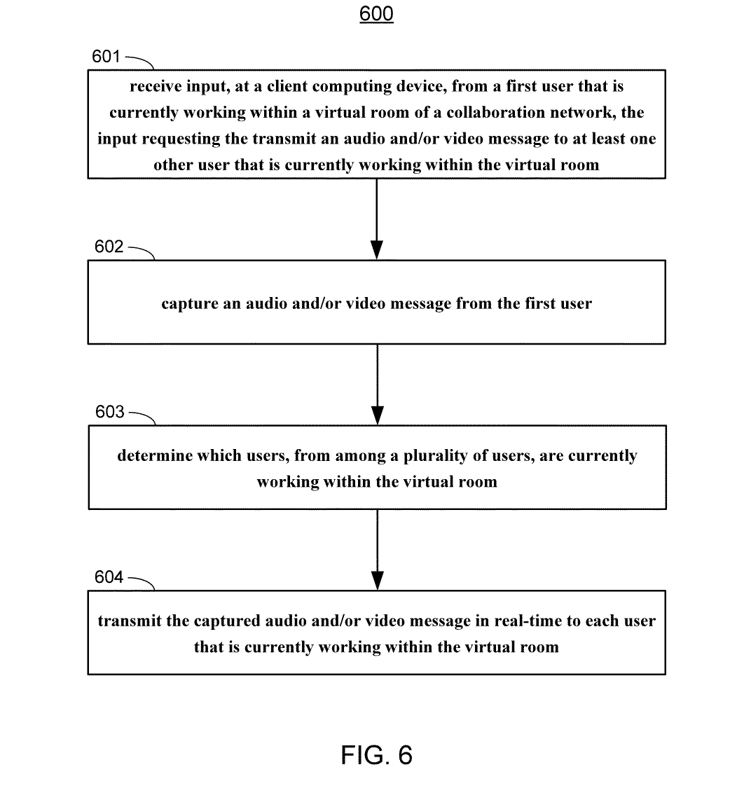

FIG. 6 illustrates a flowchart of an exemplary method 600 for generating and transmitting an audio and/or video communication to each user that is currently working within a virtual room in a collaboration network. Method 600 will be described with reference to the Figures.

Method 600 includes an act 601 of receiving input, at a client computing device, from a first user that is currently working within a virtual room of a collaboration network, the input requesting the real-time transmission of an audio and/or video message to at least one other user that is currently working within the virtual room. For example, user interface 200 can include an option that a user can select to send an audio and/or video communication to some or all of the other users in a virtual room.

Method 600 includes an act 602 of capturing an audio and/or video message from the first user. For example, the client computing device on which the user is working can capture audio (e.g. via a microphone) and/or video (e.g. via a webcam) from the user.

Method 600 includes an act 603 of determining which users, from among a plurality of users, are currently working within the virtual room. For example, the same or similar mechanism used to determine indicators 210, 211 can also be used to identify which users are currently in the virtual room.

Method 600 includes an act 604 of transmitting the captured audio and/or video message in real-time to each user that is currently working within the virtual room. For example, the captured audio and/or video message can be immediately transmitted for display on a client computing device being used by each of the other users in the virtual room.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a server computing system for providing an indication of which users of a collaboration network are working within a virtual room in the collaboration network, the method comprising:
generating a user interface of a collaboration network, the user interface including a rooms section that displays a list of virtual rooms that a user may enter, each virtual room representing a subject with respect to which a number of users of the collaboration network can collaborate, the user interface also including a current room section for displaying content of a virtual room that is selected in the rooms section, the current room section including a topics section that lists topics of a selected room, each topic representing a topic of the subject of the selected virtual room with respect to which a number of users of the collaboration network can collaborate while in the selected virtual room;
for at least one of the virtual rooms, generating an indication of the number of users of the collaboration network that are currently working in the virtual room;
for at least one of the topics within a selected virtual room, generating an indication of the number of users of the collaboration network that are currently working on the topic;
sending the generated user interface for display on one or more client computing devices such that users of the one or more client computing devices can identify the number of users of the collaboration network that are currently working in the at least one virtual room as well as the number of users of the collaboration network that are currently working on the at least one topic.

2. The method of claim 1, wherein the indication of the number of users that are currently working in the virtual room comprises a count of the number of users in a first virtual room, the count being displayed within a representation of the first virtual room included in the list of virtual rooms.

3. The method of claim 2, wherein the user interface is customized for a first user that is currently working in the first virtual room, the indication further comprising a representation of each of the users in the first virtual room, each representation being displayed within a current room section that displays contents of the first virtual room.

4. The method of claim 3, wherein at least one of the representations of the users comprises a picture of a user.

5. (canceled)

6. The method of claim 1, wherein the indication of the number of users that are currently working on the topic comprises, for at least one of the users working within the topic, a picture of the user.

7. The method of claim 1, further comprising:
determining that the number of users that are working in one or more of the virtual rooms has changed;
for the one or more virtual rooms, generating a modification to the indication of the number of users that are currently working in the virtual room; and
sending the modification to at least one of the one or more client computing devices to enable the at least one client computing device to display the modification to the indication.

8. The method of claim 1, wherein the one or more client computing devices comprises a plurality of client computing devices, the method further comprising:
receiving a request, from one of the plurality of client computing devices, to commence a conference call with each of the users that are working within a first virtual room; and
generating a conference call among the client computing devices of each of the users working within the first virtual room.

9. The method of claim 1, wherein, for each virtual room, the indication comprises a representation of each user that is working in the virtual room.

10. The method of claim 9, wherein the indication for at least one virtual room includes a control for scrolling through or expanding the indication to enable viewing more representations than are originally displayed within the indication.

11. A method performed by a client computing device for displaying an indication of which users of a collaboration network are working within a virtual room in the collaboration network, the method comprising:
generating a user interface of a collaboration network, the user interface including a rooms section that displays a list of virtual rooms that a user may enter, each virtual room representing a subject with respect to which a number of users of the collaboration network can collaborate, the user interface also including a current room section for displaying content of a virtual room that is selected in the rooms section;
for at least one of the virtual rooms, generating an indication of the number of users of the collaboration network that are currently working in the virtual room;
displaying the generated user interface on a display of the client computing device such that one or more users of the client computing device can identify the number of users of the collaboration network that are currently working in the at least one virtual room;
receiving user input that selects a first virtual room in the rooms section;
updating the current room section of the user interface by displaying a topics section that lists a plurality of topics that are available within the first virtual room, updating the current room section further including:
for each of at least one of the topics in the first virtual room, displaying an indication of the number of users that are working on the topic.

12. The method of claim 11, wherein the indication of the number of users that are currently working in the virtual room comprises a count of the number of users in the first virtual room, the count being displayed within a representation of the first virtual room included in the list of virtual rooms.

13. (canceled)

14. The method of claim 11, wherein the indication of the number of users that are working on the topic comprises a representation for each of the users working on the topic.

15. The method of claim 14, wherein each representation comprises a picture of a user.

16. The method of claim 11, wherein the indication of the number of users that are currently working in the virtual room comprises:
a count of the number of users in the first virtual room, the count being displayed within a representation of the first virtual room included in the list of virtual rooms; and
a representation for each of the users in the first virtual room, the representations being displayed within the current room section.

17. The method of claim 11, further comprising:
generating, for at least one of the virtual rooms, a modification to the indication of the number of users that are currently working in the virtual room; and
displaying the modified indication.

18. The method of claim 17, wherein the user interface includes one or more controls for commencing a conference call with each user that is currently working within a virtual room.

19. (canceled)

20. One or more computer storage media storing computer executable instructions which when executed by one or more processors perform a method for providing an indication of which users of a collaboration network are working within a virtual room in the collaboration network, the method comprising:
generating a user interface of a collaboration network, the user interface including a rooms section that displays a list of virtual rooms, each virtual room representing a subject with respect to which a number of users of the collaboration network can collaborate, the user interface also including a current room section for displaying content of a virtual room that is selected in the rooms section;
for at least one of the virtual rooms, generating a count of the number of users of the collaboration network that are currently working in the virtual room;
displaying the user interface with the indication for the at least one of the virtual rooms on a display of a client computing device;
receiving a user selection of a first of the virtual rooms listed in the rooms section;
displaying, within the current room section of the user interface, contents of the first virtual room, the contents including a representation of each user that is working within the first virtual room;
displaying, within the current room section, a plurality of topics that have been created within the first virtual room; and
displaying, for each of the plurality of topics, a representation of each user that is both working in the first virtual room and working on the topic.

21. The method of claim 11, further comprising:
receiving input, at the client computing device, from a first user that is currently working within the first virtual room, the input requesting the transmission of an audio and/or video message to at least one other user that is currently working within the first virtual room;
capturing an audio and/or video message from the first user;
determining a first subset of users that are to receive the audio and/or video message, the first subset including less than all of the users that are currently working within the first virtual room;
transmitting the captured audio and/or video message in real-time to each user in the first subset of users; and
displaying an indication, on the client computing device, of each of the users in the first subset that are receiving the captured audio and/or video message.

22. The method of claim 21, further comprising:
in response to transmitting the captured audio and/or video message, receiving an audio and/or video response from one or more of the users in the first subset of users.

23. The method of claim 22, wherein the audio and/or video response is displayed to the first user upon being received without requiring input from the first user.

24. (canceled)

25. The method of claim 21, further comprising:
receiving the selection, from the first user, of a representation of one of the other users currently working within the first virtual room; and
commencing a communication between the first user and the one other user.

26. The method of claim 21, wherein the first subset of users comprises all users that are working on a particular topic within the first virtual room.
